(19) United States
(12) Patent Application Publication
(10) Pub. No.: US 2013/0139861 A1
(43) Pub. Date: Jun. 6, 2013

(54) Crutch Apparatus and Ergonomic Retrofit Handle Kit for Adjustable Crutches

(71) Applicant: Bud Spangler, Eatontown, NJ (US)

(72) Inventor: Bud Spangler, Eatontown, NJ (US)

(21) Appl. No.: 13/680,025

(22) Filed: Nov. 17, 2012

Related U.S. Application Data
(60) Provisional application No. 61/629,413, filed on Nov. 18, 2011.

(51) Int. Cl. A61H 3/02; F16M 13/02

(52) U.S. Cl. CPC A61H 3/02; F16M 13/02
USPC 135/68; 248/201; 29/428; 29/525.02

(57) ABSTRACT

In one embodiment of the invention, extension brackets are attachable to existing crutch support members in order to outwardly extend the handle location of the crutch a given distance from the vertical plane of the support members of the crutch. An extended handle is attachable between the extension brackets by way of conventional fasteners such as wing nuts and bolts. The design and implementation of the ergonomic crutch handle kit of the present invention are significantly less complicated than designs which are known to exist in the prior art.

### RELATED APPLICATIONS

The invention claims the benefit of U.S. Provisional Application Ser. No. 61/629,413, filed Nov. 18, 2011.

### TECHNICAL FIELD

This invention relates generally to crutches and more particularly to an ergonomic handle for a crutch.

### BACKGROUND OF THE INVENTION

Some crutch designs exist in which the handle member extends into a different vertical plane than the crutch support members. These designs are, however, fairly complicated to manufacture and do not lend themselves to being easily attachable to modern day adjustable crutches. These modern day adjustable crutches typically include two outward support members that are coupled together via a shoulder support and a center support member. The center support member typically includes a plurality of apertures that extend through the center member. The center member is then attachable to the outward supports by way of one or more wing nuts and bolts, whereas the plurality of apertures in the center support enables the height of the crutch to be adjustable.

The upper portion of the outward support members include a number of apertures penetrating therethrough so as to enable a handle to be attached in a number of different locations in between the outward support members. None of the prior art handle members that could potentially be considered ergonomic would be easily adaptable to present day designs of adjustable crutches.

Accordingly, there is a need for new ergonomic handle design that would operate more easily with current day crutch designs.

### SUMMARY OF THE INVENTION

An advance is made over the prior art in accordance with the principles of the present invention that is directed to a new approach for crutch handle. In one embodiment of the invention, extension brackets are attachable to existing crutch support members in order to outwardly extend the handle location of the crutch a given distance from the vertical plane of the support members of the crutch. An extended handle is attachable between the extension brackets by way of conventional fasteners such as wing nuts and bolts. The design and implementation of the ergonomic crutch handle kit of the present invention are significantly less complicated than designs which are known to exist in the prior art.

### BRIEF DESCRIPTION OF THE DRAWING

The teachings of the present invention can be readily understood by considering the following detailed description in conjunction with the accompanying drawings, in which:

FIGS. 1A and 1B show one exemplary embodiment of a present day adjustable crutch;

FIGS. 2A and 2B show one embodiment of an adjustable crutch including an ergonomic handle in accordance with the principles of the present invention;

FIG. 3 shows one embodiment of an ergonomic handle kit for an adjustable crutch in accordance with the present invention; and

FIG. 4 shows a detailed illustration of a handle bracket utilized in connection with the ergonomic handle kit.

### DETAILED DESCRIPTION

Exemplary embodiments of the invention will now be described while referring to the figures, several of which may be simultaneously referred to during the course of the following description.

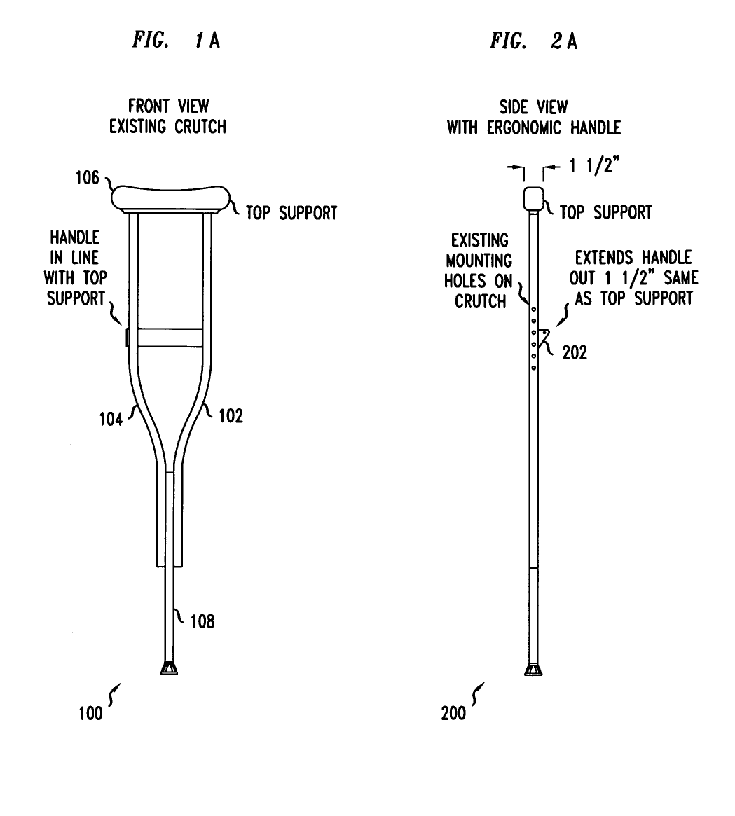

Referring to FIGS. 1A and 1B in combination, there is shown one exemplary embodiment of a present day adjustable crutch 100. The adjustable crutch includes two outward support members 102, 104 that are coupled together via a shoulder support 106 and a center support member 108. The center support member typically includes a plurality of apertures that extend through the center member. The center member 108 is then attachable to the outward supports 102, 104 by way of one or more wing nuts and bolts, whereas the plurality of apertures in the center support enable the height of the crutch to be adjustable.

The upper portion 110 of the outward support members 102, 104 include a number of apertures 112 penetrating therethrough so as to enable a handle 114 to be attached in a number of different locations in between the outward support members.

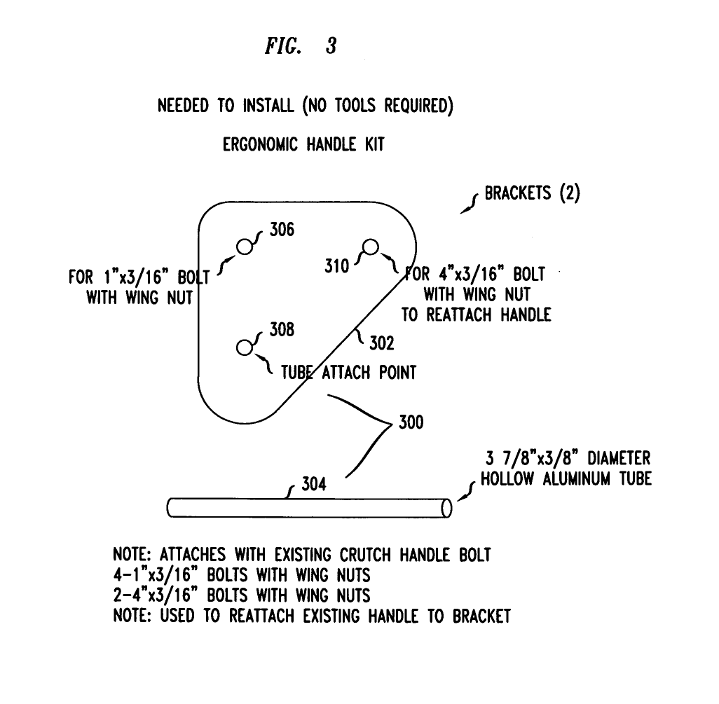

Referring to FIG. 3, there is shown one exemplary embodiment of an ergonomic handle retrofit kit 300 for a current day crutch as was described in FIG. 1. The basic elements of the kit include a first and second side plate bracket 302, a spacer tube 304 and a spacer attachment nut and bolt (or screw) described but not shown. As described, the spacer attachment bolt is a 4 inch by 3/16 inch that fits through a hollow portion of the spacer tube 304 and appropriate apertures 308 of the side plate brackets 302 when the handle retrofit kit is attached between the outward support members 102, 104. The spacer tube and hardware provide additional structural support and rigidity to the assembled crutch in place of the handle element that is moved horizontally outward, as will be explained. As shown in FIG. 3, one example of a side plate bracket is illustrated as a generally triangular metal plate having three holes placed at specific locations thereof. A first hole 306 and second hole 308 occur in a vertical plane of the side plate and are adapted so as to coincide with aperture locations of the upper portion 110 of the outward support members 102, 104 of the adjustable crutch. The support brackets are attachable to the support members at selected aperture locations 306, for example, using a nut and bolt (or screw) combination, for example, a 1 inch by 3/16 inch and wing nut. When attached to the support members, the portions of the side plate brackets 302 containing a third hole 310 face in the same direction on one side of the support members. An existing handle element 314 from the original crutch (or a new handle element if desired) may be re-attached in between the third holes 310 of the side plate brackets 302 using, for example, a 4 inch nut and bolt combination or existing hardware from the original crutch.

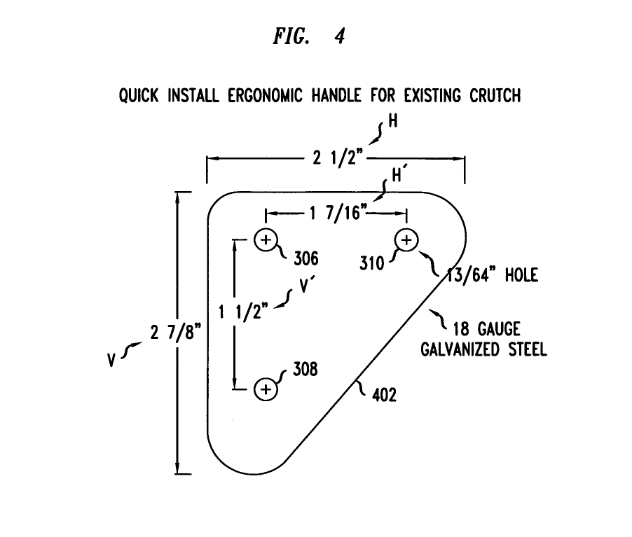

Referring to FIG. 4, there is shown one embodiment of a side plate bracket 402 having exemplary dimensions and hole locations that may applicable for a standard size adjustable crutch. For example, as shown a vertical dimension V of the bracket 402 is 2 and ⅞ inches and a horizontal dimension H is 2 and ½ inches. Exemplary vertical spacing V′ between the holes 306, 308 is 1 and ½ inches and horizontal spacing H′ between holes 306, 310 is 1 an 7/16 inches. It would be understood by a person skilled in the art that other dimensions and hole locations may be utilized in order to facilitate connection to other sized crutch supports having different aperture locations in the upper portions thereof. In addition, the bracket may be made larger or smaller (or the hole locations made in differing locations) so as to alter the horizontal distance that the handle element of the ergonomic crutch kit extends from the vertical plane of the crutch. As shown, the bracket 402 may be made from 18 gauge galvanized steel. Other suitable materials may also be utilized in order to fabricate the bracket as would be understood by those skilled in the art, including wood, plastics or combinations of suitable materials.

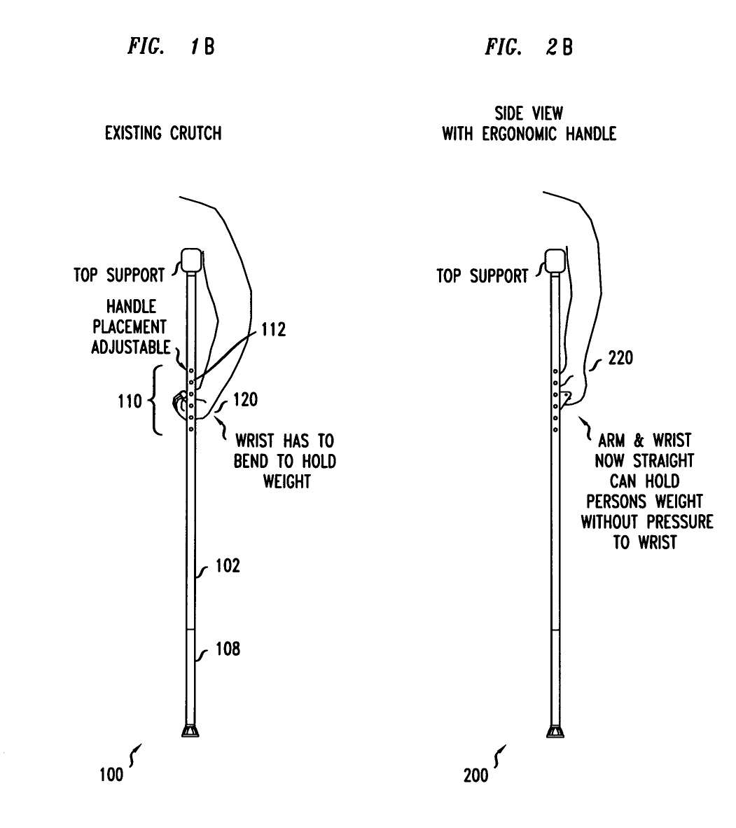

Referring to FIG. 2A, there is shown one exemplary embodiment of an adjustable crutch 200 with the ergonomic handle kit 202 of the present invention attached. As can be seen form FIG. 2A, attachment of the side plate bracket enables the handle element of the crutch to be extended horizontally outward to a given distance D. In one exemplary embodiment, this distance can be a one and one half inch outward horizontal extension from the vertical plane of the outward support members and the center support member. Other extension distances may be achieved by altering the dimensions and hole locations of the brackets 302, as would be understood.

Referring to FIGS. 1B and 2B in combination, one can see the advantages of the ergonomic retrofit handle kit when compared to the handle of an existing crutch. As shown in FIG. 1B, in order for a user to grasp the handle of the existing crutch design, the user's wrist 120 must be bent inward. This bending of the wrist while at the same time supporting the weight of the user while at wrest and in motion can cause fatigue and stress on the wrist and hand and other surrounding joints. In contrast, as shown in FIG. 2B, a user of the ergonomic crutch handle of the present invention may keep his or her wrist 220 straight while utilizing the improved crutch design of the present invention. This relieves significant pressure on the wrist and greatly reduces the onset of fatigue that is associated with prolonged usage of crutches. A significant advantage of the present invention design is that all parts from an existing crutch prior to retrofit may be re-used, e.g., the handle and its associated hardware. Implementation of the invention may be carried out simply using the retrofit extension brackets, support tube and associated hardware.

The foregoing description merely illustrates the principles of the invention. It will thus be appreciated that those skilled in the art will be able to devise various arrangements, which, although not explicitly described or shown herein, embody the principles of the invention, and are included within its spirit and scope. For example, although the extension brackets are shown as being mechanically fastened to the crutch support members, it would be understood that the crutch support members and extension brackets could be made as a unitary assembly or that the extension brackets could be welded or otherwise alternatively fastened, e.g., adhesively fastened, to the support members of the crutch. Furthermore, all examples and conditional language recited are principally intended expressly to be only for instructive purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. Many other modifications and applications of the principles of the invention will be apparent to those skilled in the art and are contemplated by the teachings herein. Accordingly, the scope of the invention is limited only by the claims.

What is claimed is:

1. A retrofit handle kit for a crutch having an adjustable handle attachable between two support members, said kit comprising:
first and second support brackets attachable at handle locations of corresponding first and second support members, said support brackets having an area that protrudes outwardly a distance D from a vertical axis of the support members;
said first and second support brackets adapted to accept a handle for attachment between said first and second support bracket at said area that protrudes, thereby extending said handle outwardly from said vertical plane of said support members a given distance, such that arms and wrists of a user of said crutch may remain generally parallel to a vertical plane of said support members when in use.

2. The kit of claim 1, further including a support tube attachable between said support brackets at a handle location of said support members, said support tube providing structural support to said support members proximate handle locations thereof.

3. The kit of claim 2, wherein said support tube is hollow and is attachable to said support members via a first aperture in said support brackets.

4. The kit of claim 3, wherein said support tube and handle are mechanically fastened between said support brackets.

5. The kit of claim 4, wherein said mechanical fastening includes a nut and bolt.

6. The kit of claim 4, further including a second aperture within each of said support brackets, said second aperture located in the same horizontal plane as said first aperture when said support brackets are attached to said support members.

7. The kit of claim 6, further including a third aperture within each of said support brackets, said third aperture located in the same vertical plane as said first aperture when said support brackets are attached to said support members.

8. The kit of claim 7, wherein said support brackets are made from 18 gauge steel.

9. The kit of claim 7, wherein said second aperture is located approximately 1 and 7/16 inches from said first aperture in the horizontal plane and said third aperture is located 1 an ½ from said first aperture in the vertical plane.

10. The kit of claim 7, further including said two support members and a center post coupled between said support members at a lower end of said support members and further including a shoulder support at a top end of said support members.

11. A method for retrofitting a crutch having an adjustable handle attachable between two support members, said method comprising:
attaching first and second support brackets at handle locations of corresponding first and second support members, said support brackets having an area that protrudes outwardly a distance D from a vertical axis of the support members;
attaching a handle between said first and second support brackets at said area that protrudes, thereby extending said handle outwardly from said vertical plane of said support members a given distance such that arms and wrists of a user of said crutch may remain generally parallel to a vertical plane of said support members when in use.

12. The method of claim 11, further including attaching a support tube between said support brackets at a handle location of said support members, said support tube providing structural support to said support members proximate handle locations thereof.

13. The method of claim 12, wherein said support tube is hollow and is attachable to said support members via a first aperture in said support brackets.

14. The method of claim 13, wherein said support tube and handle are mechanically fastened between said support brackets, wherein said mechanical fastening includes a nut and bolt.

15. The method of claim 14, further including a second aperture within each of said support brackets, said second aperture located in the same horizontal plane as said first aperture when said support brackets are attached to said support members.

16. The method of claim 15, further including a third aperture within each of said support brackets, said third aperture located in the same vertical plane as said first aperture when said support brackets are attached to said support members.

17. The method of claim 7, wherein said second aperture is located approximately 1 and 7/16 inches from said first aperture in the horizontal plane and said third aperture is located 1 an ½″ from said first aperture in the vertical plane.

18. A crutch apparatus, comprising:
two support members and a center post coupled between said support members at a lower end of said support members and further including a shoulder support at a top end of said support members.
said crutch adapted to accept an adjustable handle attachable between said support members, further including:
first and second support brackets attachable at handle locations of corresponding first and second support members, said support brackets having an area that protrudes outwardly a distance D from a vertical axis of the support members;
said first and second support brackets adapted to accept a handle for attachment between said first and second support bracket at said area that protrudes, thereby extending said handle outwardly from said vertical plane of said support members a given distance, such that arms and wrists of a user of said crutch may remain generally parallel to a vertical plane of said support members when in use;
further including a support tube attachable between said support brackets at a handle location of said support members, said support tube providing structural support to said support members proximate handle locations thereof, wherein said support tube is hollow and is attachable to said support members via a first aperture in said support brackets, wherein, wherein said support tube and handle are mechanically fastened between said support brackets;
further including a second aperture within each of said support brackets, said second aperture located in the same horizontal plane as said first aperture when said support brackets are attached to said support members; and
further including a third aperture within each of said support brackets, said third aperture located in the same vertical plane as said first aperture when said support brackets are attached to said support members.
